(19) United States
(12) Patent Application Publication
(10) Pub. No.: US 2015/0272253 A1
(43) Pub. Date: Oct. 1, 2015

(54) HARD HAT WITH ADDITIONAL TECHNICAL FEATURES

(71) Applicants: Michael Eugene Orientale, Briarcliff Manor, NY (US); Robert Michael Boder, Briarcliff Manor, NY (US); Andres Marcos, San Antonio, TX (US)

(72) Inventors: Michael Eugene Orientale, Briarcliff Manor, NY (US); Robert Michael Boder, Briarcliff Manor, NY (US); Andres Marcos, San Antonio, TX (US)

(21) Appl. No.: 14/736,630

(22) Filed: Jun. 11, 2015

Related U.S. Application Data
(62) Division of application No. 14/169,812, filed on Jan. 31, 2014.
(60) Provisional application No. 61/759,217, filed on Jan. 31, 2013.

(51) Int. Cl. A42B 3/04; G07C 9/00; A42B 3/06

(52) U.S. Cl. CPC A42B 3/0433; A42B 3/06; G07C 9/00111

(57) ABSTRACT

A hard hat with an attached tracking mechanism is provided. The tracking mechanism may include a radio-frequency identification tag. The tracking mechanism may be used to validate and monitor the presence of workers on a job site. The hard hat may further include a head lamp with a built in motion sensor and audio sensor for safety. The hard hat may further include temperature regulators as well as a communication system for communicating with other users.

### CROSS-REFERENCE TO RELATED APPLICATION

This application claims the benefit of priority of U.S. provisional application No. 61/759,217, filed Jan. 31, 2013, and is a Divisional application of U.S. non-provisional application Ser. No. 14/169,812, filed Jan. 31, 2014 the contents of which are herein incorporated by reference.

### BACKGROUND OF THE INVENTION

The present invention relates to a hard hat and, more particularly, to a hard hat with safety and tracking features.

Safety, security, risk and accountability are ongoing problems for both employers and employees on construction, other site related projects and facilities maintenance efforts. Injuries, theft and lack of accountability expose everyone involved in these projects to financial and legal risk and possible loss of life. Other attempts to enhance the construction hard hat have been narrow in nature and not adopted by the construction or other industries. The technical enhancements have been expensive and bulky. Further, the enhancements fail to address security, safety, risk and accountability in a meaningful and comprehensive manner.

As can be seen, there is a need for a hard hat with safety and tracking features.

### SUMMARY OF THE INVENTION

In one aspect of the present invention, a safety head wear comprises: a hard hat comprising an inner surface and an outer surface, wherein the inner surface is formed to fit on a user's head, and the outer surface is configured to protect the user's head; a tracking mechanism attached to the hard hat, wherein the tracking mechanism is detected by at least one detector; and an alarm system comprising at least one of a light and a speaker.

In another aspect of the present invention, a system for tracking workers comprises: at least one computer comprising a display; at least one hard hat comprising a built in radio-frequency identification chip; at least one radio-frequency detector attached at a job site, wherein the radio-frequency detector is operatively connected to the computer; and a program product comprising computer readable program code, causing, when executed, the computer to perform the following process steps: indicating when the at least one hard hat is within the job site; and displaying where the at least one hard hat is within the job site.

These and other features, aspects and advantages of the present invention will become better understood with reference to the following drawings, description and claims.

### BRIEF DESCRIPTION OF THE DRAWINGS

FIG. 1 is a perspective view of the prior art;

FIG. 2 is a perspective view of the present invention with a plurality of devices attached to hard hat;

FIG. 3 is a perspective view an alternate embodiment of the present invention;

FIG. 4 is a perspective view an alternate embodiment of the present invention;

FIG. 5 is a perspective view an alternate embodiment of the present invention;

FIG. 6 is a perspective view an alternate embodiment of the present invention; and

FIG. 7 is view of a job site illustrating an exemplary system of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a hard hat with an attached tracking mechanism. The tracking mechanism may include a radio-frequency identification tag. The tracking mechanism may be used to validate and monitor the presence of workers on a job site. The hard hat may further include a head lamp with a built in motion sensor and audio sensor for safety. The hard hat may further include temperature regulators as well as a communication system for communicating with other users.

The present invention may include a construction hard hat with various built in technical features. With the built in technical features of the present invention, employers and employees are able to mitigate both legal and financial risk by preventing injuries and death, increasing accountability and compliance, and improving productivity during a project.

The present invention may increase safety when facing fires, power outages, workers in distress, behavior of the workers, and code requirements. The present invention may increase security on the job site by preventing unauthorized personnel on the site, vandalism, and theft. The present invention may increase risk mitigation by preventing fraudulent insurance claims and validating certified payroll and MWBE requirements. The present invention may increase work productivity by tracking productivity across the jobsite, having a field labor management tool, and documenting labor force activities on-site.

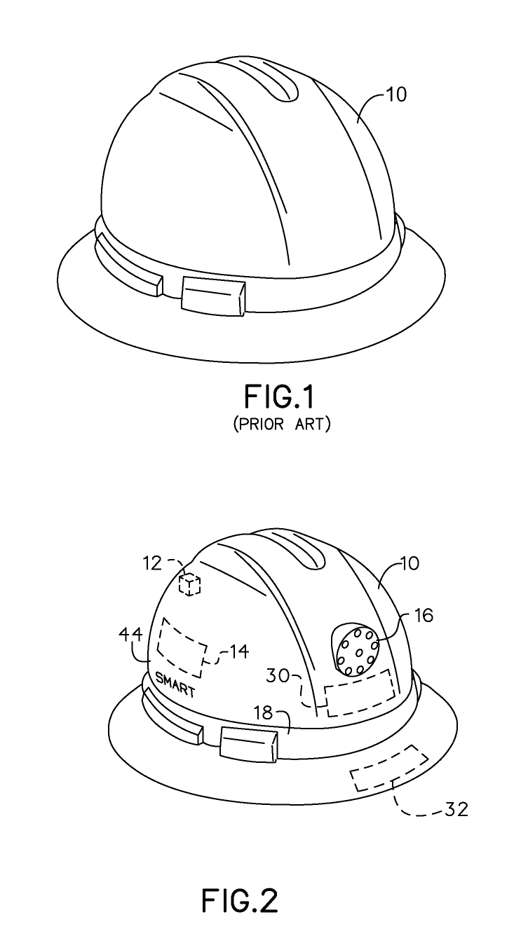

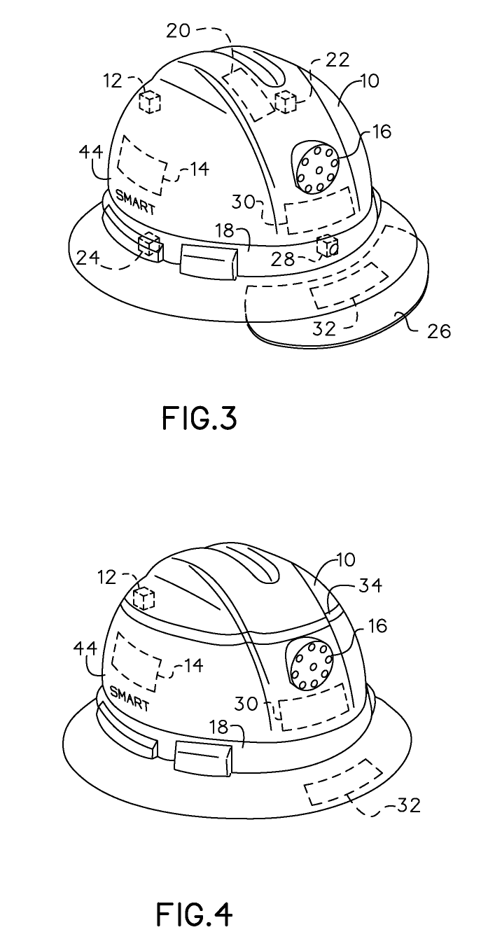

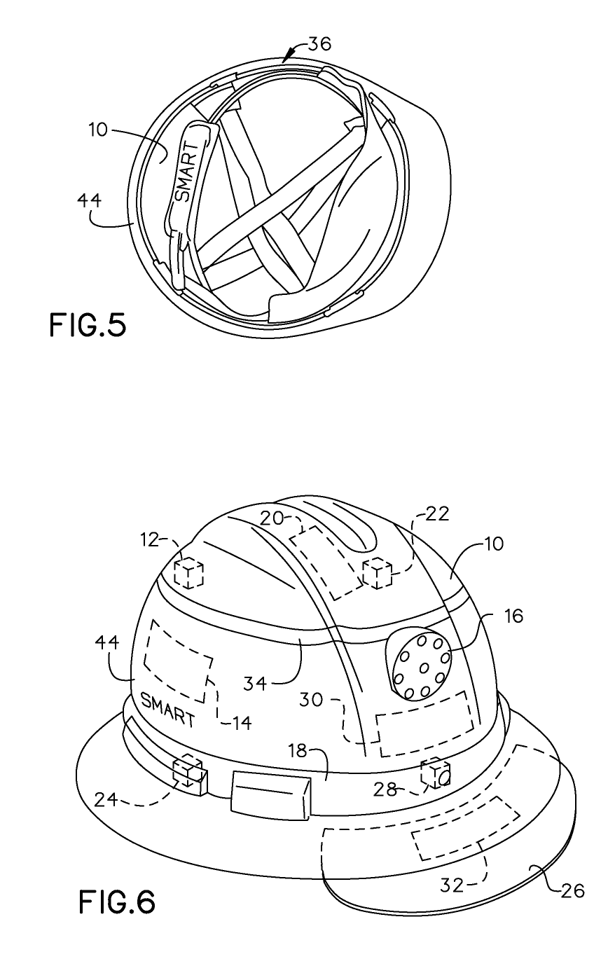

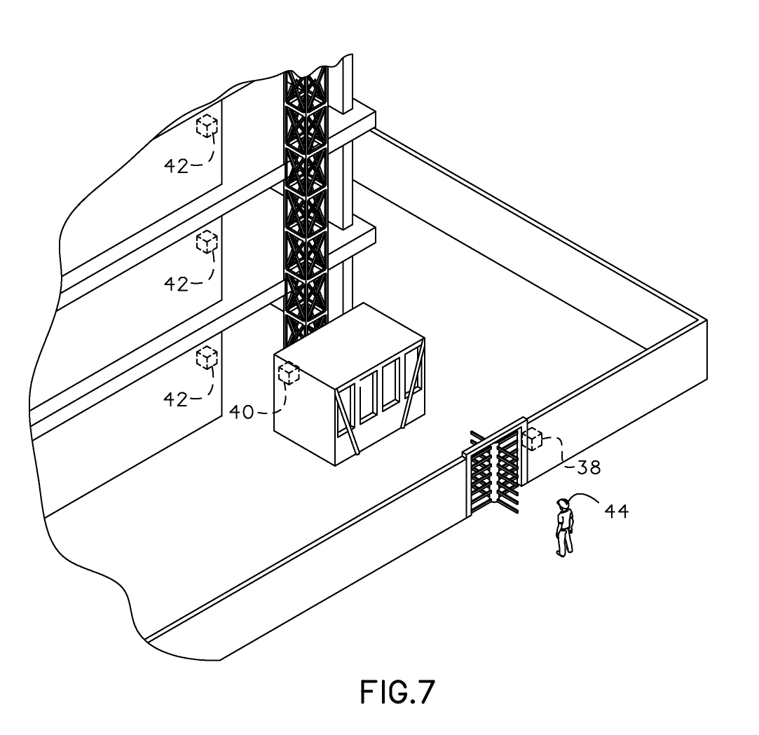

Referring to FIGS. 1 through 7, the present invention may include a safety head wear 10, such a “smart” construction hard hat 44. The hard hat 44 may include an inner surface formed to fit on a user's head and an outer surface to protect the user's head. The hard hat 44 may be made of a high density polyethylene or other suitable material. The additional components of the present invention may be attached to the hard hat 44 or may be attached to an insertable sleeve 36 that fits within the hard hat 44.

The present invention may include a built in tracking mechanism 12 in the hard hat 44. The built in tracking mechanism 12 may be a radio-frequency identification (RFID) tag or other tracking technology. The tracking mechanism 12 may be used to validate and monitor the presence of workers on a job site. Further, the tracking mechanism 12 may be utilized at the entry of the site and/or locate the workers throughout the site.

In certain embodiments, the tracking mechanism 12 may be used with software on a computer. In such embodiments, the job site may include an RFID detector 40 near the entrance 38 of the job site, such as a turnstile. Further, a plurality of RFID detectors 40 and closed-circuit television (CCTV) cameras 42 may be placed in various locations of the job site. The RFID detectors 40 and

CCTV cameras 42 may be operatively connected to the computer. A display connected to the computer may indicate when a hard hat 10 has entered the job site and may display where the hard hat is within the job site. The users may track hard hats 44 using a three dimensional map. For example, Building Information Modeling (BIM) may be utilized, which is a process involving the generation and management of digital representations of physical and functional characteristics of places. Further, a camera 28 may be attached to the hard hat 10, in which video may be displayed by the computer to show the view of the hard hat wearer.

In certain embodiments, the hard hat 44 of the present invention may include an identification number 14 printed on the outer surface. The identification number 14 may be on each worker's hard hat 44 and may include a unique number to easily track the hard hats 44. The identification number 14 may be displayed on the computer when tracking the hard hat 44 to indicate which hard hat 44 is being tracked. The hard hat 44 may further include a color band 18 printed on the surface. This color band 18 may distinguish different work trades. For example, each trade subcontractor may have a unique color representing its trade. The company logo 30, i.e. the name of the employer, may also be printed on the outer surface of the hard hat 44.

The present invention may further include an eye shield 26. The eye shield 26 may be retractable and extendable and may be used to protect the user's eyes. In certain embodiments, the eye shield 26 may utilize a head-up display technology. Therefore, certain data may be displayed to the user. This may include data collected by sensors on the hard hat 44, data sent to the user by an outside source, messages from the outside source, and the like. The shield 26 may also include a logo 32, such as the name of the product or company.

In certain embodiments, the hard hat 44 of the present invention may include temperature regulating devices attached to the inner surface. For example, the present invention may include a heat pad 20 for colder weather, and a cooling pad 20 for hotter weather. In certain embodiments, the hard hat 44 of the present invention may further include an internal fan 22. The internal fan 22 may be used as a ventilation system for keeping the workers cool.

The present invention may further include a communication system hooked up to the hard hat 44. The communication system may include a speaker and microphone 24 for a phone and/or radio system. The phone system may include a built in phone or a Bluetooth device connected with the cellular phone of the user. Further, the radio system may be connected with other hard hats 44 and other third parties for communication on the job site. The communication system may be used for emergency situations or for communicating requests.

In certain embodiments, the present invention may include a head lamp 16 attached to the outer surface of the hard hat 44. The head lamp 16 hands free lighting system that helps guide workers through site during day to day activities and during power outages. The head lamp 16 may be Light Emitting Diodes or any suitable light. In certain embodiments, the head lamp 16 may be in sync with an alarm system, and may flash when in distress. A speaker may also be used to emit auditory alerts for distress. In certain embodiments, the head lamp 16 may include an audio or motion sensor to alert workers to dangers, such as obstructions or holes.

The present invention may be utilized with a plurality of alternate embodiments. For example, the hard hat 44 may be a collapsible to enable easy transport and storage. The hard hat 44 may include a danger alert system 34 for fall protection. In certain embodiments, the hard hat head band insertion 36 may be used as an alternative to the components being built into the hard hat 44 shell. The head band 36 may be used with all current conventional hard hat outer shells. Further, the present invention may be used with a plurality of different industries including but not limited to any work in which helmets or hard hats are used, such as mining operations, road work and the like.

At least a portion of the present invention may be computer based. The computer-based data processing system and method described above is for purposes of example only, and may be implemented in any type of computer system or programming or processing environment, or in a computer program, alone or in conjunction with hardware. The present invention may also be implemented in software stored on a computer-readable medium and executed as a computer program on a general purpose or special purpose computer. For clarity, only those aspects of the system germane to the invention are described, and product details well known in the art are omitted. For the same reason, the computer hardware is not described in further detail. It should thus be understood that the invention is not limited to any specific computer language, program, or computer. It is further contemplated that the present invention may be run on a stand-alone computer system, or may be run from a server computer system that can be accessed by a plurality of client computer systems interconnected over an intranet network, or that is accessible to clients over the Internet. In addition, many embodiments of the present invention have application to a wide range of industries. To the extent the present application discloses a system, the method implemented by that system, as well as software stored on a computer-readable medium and executed as a computer program to perform the method on a general purpose or special purpose computer, are within the scope of the present invention. Further, to the extent the present application discloses a method, a system of apparatuses configured to implement the method are within the scope of the present invention.

It should be understood, of course, that the foregoing relates to exemplary embodiments of the invention and that modifications may be made without departing from the spirit and scope of the invention as set forth in the following claims.

What is claimed is:

1. A system for tracking workers comprising:
at least one computer comprising a display;
at least one hard hat comprising a built in radio-frequency identification chip;
at least one radio-frequency detector attached at a job site, wherein the radio-frequency detector is operatively connected to the computer; and
a program product comprising computer readable program code, causing, when executed, the computer to perform the following process steps: indicating when the at least one hard hat is within the job site; and displaying where the at least one hard hat is within the job site.

2. The system of claim 1, further comprising a plurality of closed-circuit televisions dispersed within the job site and operatively connected to the computer.

3. The system of claim 1, wherein the radio-frequency detector is part of an insert that is removeably attachable to the hard hat.

4. The system of claim 1, an alarm system comprising at least one of a light and a speaker.

5. The system of claim 4, wherein the alarm system's activation is displayed on the computer display.

6. The system of claim 1, further comprising at least one of a motion sensor and an audio sensor operatively connected to the computer, wherein a plurality of readings of the at least one motion sensor and audio sensor are displayed on the computer display.

7. The system of claim 1, further comprising an identification number displayed on the outer surface of the hard hat and on the display of the computer.

8. The system of claim 1, further comprising a speaker and a microphone attached to the inner surface of the hard hat, wherein the speaker and the microphone are connected to at least one of a phone system and a radio system.
